(19) United States
(12) Patent Application Publication
(10) Pub. No.: US 2004/0022531 A1
(43) Pub. Date: Feb. 5, 2004

(54) Camera lens focus setting for low brightness scenes

(76) Inventor: Charles E. Schinner, Windsor, CO (US)

Correspondence Address: HEWLETT-PACKARD COMPANY, Intellectual Property Administration, P. O. Box 272400, Fort Collins, CO, 80527-2400, US

(21) Appl. No.: 10/209,979

(22) Filed: Jul. 31, 2002

(51) Int. Cl. G03B 7/00

(52) U.S. Cl. 396/67

(57) ABSTRACT

A camera has a lens focus setting procedure for use when a scene being photographed has low brightness. If the scene brightness indicates that a strobe is required, aperture may optionally be decreased, and the lens focus setting is such that the focal distance is within the range of the strobe.

### FIELD OF INVENTION

This invention relates generally to cameras and more specifically to adjustable focus for cameras.

### BACKGROUND OF THE INVENTION

Some cameras have various forms of semi-automatic focus, where focal distance is determined by a manually set camera mode. Some cameras have fully automatic focusing. Cameras with fully automatic focusing commonly analyze a digital image from a photosensor array and adjust the focal distance of a lens until image edge contrast is maximized. There are several circumstances under which image edge contrast maximization may not provide a suitably focused image. One example is a scene with low brightness. There is a need for suitably focused photographs even when automatic scene edge contrast maximization may not provide a suitably focused image.

### SUMMARY OF THE INVENTION

A camera has a lens focus setting procedure for use when the scene being photographed has low brightness. If the scene brightness indicates that a strobe is required, aperture may optionally be decreased, and the lens focus setting is such that the focal distance is within the range of the strobe.

### BRIEF DESCRIPTION OF THE DRAWINGS

FIG. 1 is a block diagram of an example embodiment of a camera suitable for use with the invention.

FIG. 2 is a flow chart of an example embodiment of the invention.

### DETAILED DESCRIPTION OF THE PREFERRED EMBODIMENT OF THE INVENTION

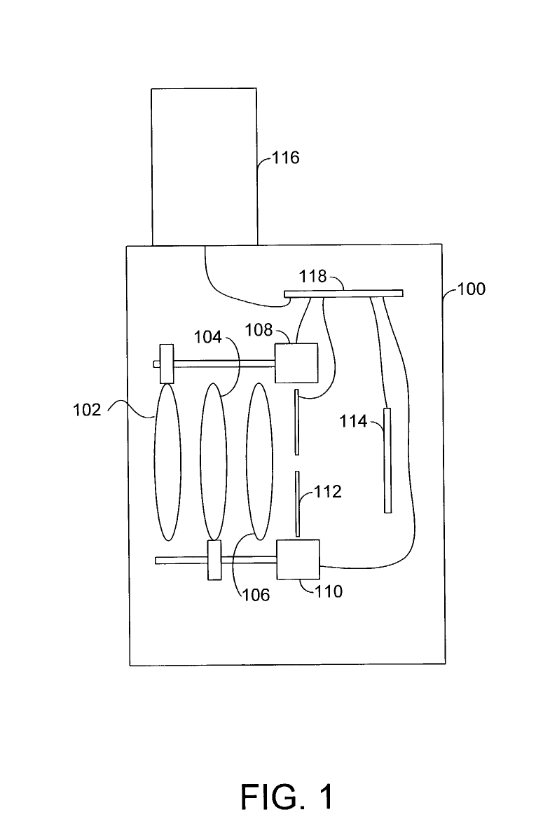

FIG. 1 illustrates an example camera with automatic focus. The invention is not limited to automatic focus cameras, but the invention is particularly useful for reducing delay and providing suitable images under conditions for which automatic focus may not result in a satisfactory image. In FIG. 1, a camera 100 includes an example lens system that has a first moveable group of elements 102, a second moveable group of elements 104, and a stationary group of elements 106. The number of moveable and stationary groups of elements is arbitrary and is for illustration only. Other suitable lens designs may have only one moving group of elements, or more than two moving groups of elements, or all groups of elements may move. In the example of FIG. 1, a first motor 108 drives a lead screw, which is attached to a follower nut attached to the first moveable group of elements 102. A second motor 106 drives a lead screw, which is attached to a follower nut attached to the second moveable group of elements 104. The moveable groups of elements are moved independently to provide both zoom and focus.

Camera 100 also includes a variable aperture 112. The variable aperture may be part of the lens system, but may be separate. The variable aperture may be mechanical or electronic. A photosensor array 114 is used for focus control and to measure the brightness of light from a scene. In a digital camera, the photosensor array 114 may also be used as the imaging array. A strobe 116 is used in low-light conditions. The strobe may or may not be attached to the camera. A processor/controller 118 receives images or light intensity data from the photosensor array and controls the lens system, the variable aperture, and the strobe. The lens system may have continuously variable focus. Alternatively, the lens system may have multiple discrete focus settings, which may be numbered, with each setting providing a predetermined focal distance. The aperture may be continuously variable, or may have multiple discrete settings.

If a camera lens system is focused so that the focal distance is less than infinity, then objects at distances closer to the camera than the focal distance have some blur, and objects at distances farther away than the focal distance have some blur. For any camera lens system, and imaging or viewing technology, there exists an acceptable blur that is sufficiently small that it does not adversely affect the resolution of the overall system, or is imperceptible to the average human eye. The acceptable blur is typically specified as the diameter of a circle on the film plane or photosensor array plane, and is called blur diameter (also called Circle of Confusion). There are numerous physical limitations that may indirectly impose an acceptable blur diameter at the film plane or photosensor array plane. For example, for film, a blur smaller than a silver grain in the film emulsion will not be noticeable. For photosensor arrays, a blur smaller than the pitch of individual photosensors will not be noticeable. For digital displays, a blur smaller than the pitch of individual display elements will not be noticeable. Alternatively, acceptable blur may be defined in terms of the average human eye, for example, the ability to resolve lines at a particular spacing when viewed from a particular distance. For a camera lens system, with a focal distance that is less than infinity, and a specified acceptable blur diameter, there is distance nearer to the camera than the focal distance, at which blur exceeds the specified acceptable blur diameter, and a far point farther away from the camera than the focal distance, at which blur exceeds the specified acceptable blur diameter. The difference between the far point and the near point is the depth of field, and the blur for objects within the depth of field is less than the specified acceptable blur diameter.

A camera lens system may be focused so that the focal distance is infinity. Alternatively, a camera lens system may be focused so that the focal distance is less than infinity, and the depth of field extends just to infinity. The focal distance, when the depth of field extends just to infinity, is called the hyper focal distance. The hyper focal distance H may be approximated by the following formula:

H=−fA/B Equation 1

where f is the focal length, A is the aperture, and B is an acceptable blur diameter at the film plane or photosensor array plane. See, for example, Warren J. Smith, Modern Optical Engineering, 2nd. ed. (Boston: McGraw-Hill, 1990), pp. 145-148.

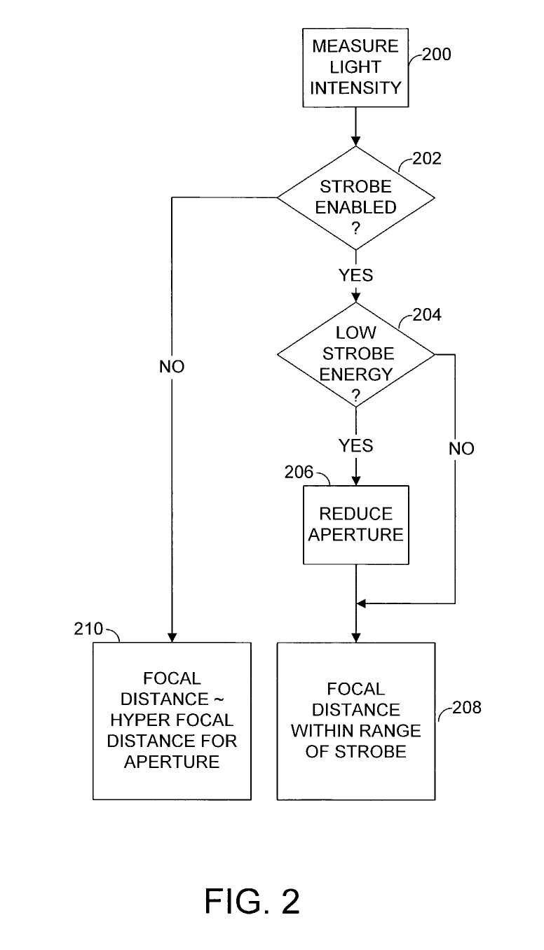

FIG. 2 illustrates an example embodiment of a method in accordance with the invention. In the illustrated method, the camera chooses a lens focus setting, and optionally an aperture setting, that is likely to produce an acceptable image. At step 200, the brightness (light intensity) of the viewed scene is measured. For example, in the camera of FIG. 1, the photosensor array 114 may be used to measure the brightness.

There is a low scene brightness threshold below which automatic focus either will fail or is unlikely to be accurate. If automatic focus is attempted in low light conditions, the result may be a long delay as the camera sweeps the lens thorough a wide range of focus settings trying to find a suitable scene edge contrast. If the scene brightness is below this low threshold, then there is no need to attempt automatic focus. In FIG. 2, if the brightness is below this low threshold, and if the strobe is enabled, then at step 208, the camera adjusts the lens focus setting so that the focal distance is within the range of the strobe, given a particular strobe energy, aperture, focal length, and sensitivity (film speed or digital image sensor sensitivity). The focal distance may be fixed, or may be variable (dependent on the strobe energy, aperture, sensitivity, and focal length).

Instead of merely ensuring that the focal distance is within the range of the strobe, the focal setting may be optionally be selected to further increase the likelihood of a suitably focused image. Given H (the hyper focal distance for the aperture), and D_{F} (the longest distance from the lens that is sharp when the lens system is focused at U), the focal distance U may be computed as follows:

U=D_{F}*H/(D_{F}+H) Equation 2

One possible choice for D_{F} is the maximum working distance of the strobe. If D_{F} is the maximum working distance of the strobe, and U is computed as in Equation 2, then the depth of field extends to the maximum working distance of the strobe. Alternatively, some margin may be provided by setting D_{F} to a percentage of the maximum working distance of the strobe, for example, 90%.

The likelihood of a suitably focused image may be increased by increasing the depth of field of the lens system. In general, depth of field for a lens system increases as aperture decreases. Accordingly, if lighting conditions permit aperture to be decreased for flash photos, then the likelihood of a suitably focused image is improved by decreasing the aperture. A common specification for strobes is the maximum energy used for one flash. Film cameras commonly fire a strobe using maximum energy, and use a photosensor to determine the duration of the flash. Digital cameras sometimes provide a pre-flash, or other means, to determine an appropriate strobe energy. A camera may use one strobe for both a pre-flash and for a flash during the final exposure. For example, a camera may use a strobe with 5% of the maximum strobe energy for a pre-flash. Alternatively, a camera may use a separate light source for a pre-flash, for example, an LED, which may generate light in a human visible band of wavelengths, or may generate light in, for example, infrared wavelengths.

The digital image resulting from exposure during the pre-flash may indicate that the maximum strobe energy is needed to provide a suitable exposure. Alternatively, the digital image resulting from exposure during the pre-flash may indicate that, for example, only 20% of the maximum strobe energy is needed to provide suitable exposure, for the aperture used during pre-flash. For purposes of ensuring a suitably focused image, if less than maximum strobe energy is needed, the aperture may be decreased, resulting in an increased depth of field, resulting in an increased likelihood of a suitably focused image. If aperture is decreased, then strobe energy needs to be correspondingly increased. Aperture may be decreased to the smallest aperture, or to an aperture at which maximum strobe energy is needed, whichever occurs first. Accordingly, if the camera determines that the aperture can be decreased without impacting exposure (FIG. 2, step 204), then (optionally) aperture may be decreased (FIG. 2, step 206). Aperture affects the computation of the hyper focal distance (Equation 1), which in turn affects the computation of a focal distance based on the maximum working distance for the strobe (Equation 2).

If the scene being photographed has low brightness, and the flash is not enabled, then a reasonable assumption is that a night scene is being photographed. In FIG. 2, if the scene being photographed has low brightness (step 200), and if the flash is not enabled (step 202), then the focal distance is set to the hyper focal distance for the lens aperture and focal length (step 210). It may also be appropriate for a night scene to open the aperture to the maximum aperture.

The example embodiment may be implemented in a camera without automatic focus. The example embodiment may be implemented in a digital camera or in a film camera. Various choices for lens focus settings may be pre-computed and stored in a camera in the form of a look-up table, for example, a focus position look-up table as a function of focal length. Alternatively, a camera may compute a suitable focal distance in real time. If discrete choices are provided in a look-up table, or if focus or aperture can only be set to discrete values, then a nearest value may be chosen. For discrete values, the focal distance may not be precisely the hyper focal distance, but is substantially the hyper focal distance (within the tolerance imposed by the discrete values).

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A camera, comprising:
a photosensor;
a strobe having a predetermined range; and
a focus setting of the lens system being set automatically by the camera, providing a focal distance of the lens system within the predetermined range of the strobe, when the brightness of light received by the photosensor is below a predetermined threshold.

2. The camera of claim 1, further comprising:
the strobe having a maximum working distance;
the focus setting of the lens system providing a depth of field of the lens system that extends to the maximum working distance of the strobe, when the brightness of light received by the photosensor is below the predetermined threshold.

3. The camera of claim 2, further comprising:
a variable aperture;
the strobe having a maximum energy;
the variable aperture, being set automatically by the camera, to be smaller than a first aperture when the maximum energy of the strobe is not needed at the first aperture.

4. A camera, comprising:
a strobe having a predetermined maximum working distance;
a lens system; and
a focus setting of the lens system being set automatically by the camera to provide a depth of field that extends to the maximum working distance of the strobe.

5. The camera of claim 4, further comprising:
a variable aperture;
the variable aperture being set automatically by the camera to be smaller than a first aperture, when an evaluation of a pre-flash image by the camera indicates that the strobe does not require maximum strobe energy at the first aperture.

6. A camera, comprising:
a strobe having a maximum strobe energy;
a variable aperture; and
the variable aperture set automatically by the camera to an aperture that is smaller than a first aperture, when an evaluation of a pre-flash image by the camera indicates that the strobe does not require maximum strobe energy at the first aperture.

7. A camera, comprising:
means for measuring brightness of a scene; and
means for automatically adjusting, by the camera, a focus setting of a lens system providing a focal distance of the lens system within a predetermined range of a strobe, when the brightness of light received by the photosensor is below a predetermined threshold.

8. A method, comprising:
measuring, by a camera, brightness of a scene;
adjusting, automatically by the camera, a focus setting of a lens system so that the focal distance for the lens system is within a predetermined range of a strobe, when the measured brightness is below a threshold.

9. The method of claim 8, further comprising:
determining, by the camera, at a first aperture, that less than maximum power for the strobe is needed; and
decreasing, automatically by the camera, the aperture to be smaller than the first aperture, when less than maximum power for the strobe is needed at the first aperture.

10. A method, comprising:
determining, by a camera, that a strobe is needed;
adjusting, automatically by the camera, a focus setting of a lens system so that a depth of field of the lens system extends to a maximum working distance of the strobe.

11. The method of claim 10, further comprising:
determining, by the camera, at a first aperture, that less than maximum power for the strobe is needed; and
decreasing, automatically by the camera, the aperture to be smaller than the first aperture, when less than maximum power for the strobe is needed at the first aperture.

12. A method, comprising:
determining, by a camera, at a first aperture, that less than maximum power for a strobe is needed; and
decreasing, automatically by the camera, the aperture to be smaller than the first aperture, when less than maximum power for the strobe is needed at the first aperture.

13. A method, comprising:
determining, by a camera, that brightness of a scene is less than a predetermined threshold;
determining, by the camera, that a strobe is not enabled; and
adjusting, automatically by the camera, a focus setting of a lens system so that a depth of field of the lens system extends to infinity.

14. A method, comprising:
determining, by a camera, that brightness of a scene is less than a predetermined threshold; and
adjusting, automatically by the camera, without attempting auto-focus, a focus setting of a lens system so that the focal distance for the lens system is within a predetermined range of a strobe.

15. The method of claim 14, further comprising:
adjusting the focus setting of the lens system so that a depth of field of the lens system extends to a maximum working distance of the strobe.
